(19) United States
(12) Patent Application Publication
(10) Pub. No.: US 2026/0266693 A1
(43) Pub. Date: Sep. 10, 2026

(54) APPARATUS AND METHOD FOR SIMULATING THE TYRE BEHAVIOR IN A PLUNGER TEST

(71) Applicant: Bridgestone Europe NV/SA [BE/BE], Zaventem (BE)

(72) Inventor: Roberto Marcello, Roma (IT)

(21) Appl. No.: 18/876,217

(22) PCT Filed: Jun. 23, 2023
(86) PCT No.: PCT/EP2023/067203

§ 371 Date: Dec. 18, 2024

(30) Foreign Application Priority Data
Jun. 27, 2022 (EP) 22181254.8

(51) Int. Cl. G01M 17/02; G01N 3/08

(52) U.S. Cl. CPC G01M 17/02; G01N 3/08; G01N 2203/0042

(57) ABSTRACT

Apparatus for simulating a tire behavior in a plunger test, comprising a ground plate suitable for being firmly fixed to a tire supporting hub of a plunger test machine, a supporting plate being movably connected to the ground plate by damping means, wherein the damping means allow a displacement only along a preferred axis of translation, a pneumatic or hydraulic actuator being connected to the supporting plate, wherein the pneumatic or hydraulic actuator is suitable for being filled with a compressed fluid when in operation and wherein the pneumatic or hydraulic actuator comprises an actuator piston, activating means being connected to the ground plate and suitable to trigger the discharge of the compressed fluid in the pneumatic or hydraulic cylinder when activated, switching means connected to the supporting plate suitable to engage the activating means when the supporting plate is being displaced, wherein the supporting plate is suitable to being moved along the preferred axis of translation when a displacement is applied to the actuator rod.

### TECHNICAL FIELD

The present invention relates to an apparatus and a method for substituting a tire in a tire strength test and simulating its physical behavior during the same.

### BACKGROUND

The tire strength test or “plunger test” is one of the several mandatory test requirements a tire has to pass according to specific national regulations to receive the necessary governmental certification and be released to the market.

The DOT FMVSS 139 for the United States of America is one example of such regulations.

During the tire strength test or “plunger test” the force applied to the tire at the center of the tread width through a plunger rod and the displacement due to tire deformation are measured by the tire strength test machine or plunger test machine until the tire breaks for a puncture caused by the plunger rod.

At that breaking point the energy applied to break the tire is calculated with a formula given by the regulation: Energy=force×displacement divided by 2.

Depending on the energy required to break the tire, the tire will pass or fail the tire strength test or “plunger test”.

As is immediately evident, the tire strength test or “plunger test” is a destructive test, because at the end of the test the tire will be broken since it suffered a puncture and must be disposed, accordingly it cannot be used any longer or even a second time.

This poses a drawback when different test machines (and consequently their test results) need to be correlated with each other or even when the performance stability of the same machine needs to be monitored.

There is therefore an increasing need to find an alternative to the usage of a real tire in these kind of tests so to be able to repeatedly and comparably reproduce the same behavior of a tire over time and with different machines.

KR20120092965A discloses a tire tread strength and bead deviation testing apparatus, and more particularly, a tire tread strength and bead tread test which can be performed simultaneously in a single tester, while automatically measuring and measuring the load and displacement to be tested.

### DESCRIPTION OF THE INVENTION

The present invention provides an apparatus for simulating a tire behavior in a plunger test that is free from the above disadvantages of the prior art and that is, in particular, easy and inexpensive to implement.

The present invention further provides a method for simulating a tire behavior in a plunger test that is free from the above disadvantages of the prior art and that is, in particular, easy and inexpensive to implement.

According to this invention, an apparatus is provided for simulating a tire behavior in a plunger test and a related method for simulating a tire behavior in a plunger test, as set out in the appended claims.

The apparatus comprises a ground plate suitable for being firmly fixed to a plunger test machine, a supporting plate being movably connected to the ground plate by damping means, a pneumatic or hydraulic actuator being connected to the supporting plate and comprising an actuator piston, activating means suitable to trigger the discharge of the pneumatic or hydraulic cylinder, switching means suitable to engage the activating means when the supporting plate is being displaced.

The apparatus may further comprise guiding means connected to the ground plate guiding the supporting plate when it is being displaced.

The apparatus may further comprise a displacement gauge suitable to measure the relative displacement between the ground plate and the supporting plate.

The ground plate is suitable for being firmly fixed to a tire supporting hub of a plunger test machine.

The ground plate is preferably fixed to a tire supporting hub of a plunger test machine through fixing means.

The damping means connecting the supporting plate to the ground plate allow a displacement only along a preferred axis of translation.

The supporting plate is suitable for being moved along the preferred axis of translation when a displacement is applied to the actuator piston.

The ground plate and the supporting plate preferably have the same shape and dimension as well as the same surface area.

The pneumatic or hydraulic actuator connected to the supporting plate, is suitable for being filled with a compressed fluid when in operation.

The pneumatic or hydraulic actuator is a pneumatic cylinder.

The activating means may be connected to the ground plate. The activating means may be firmly connected to the ground plate.

The activating means are suitable to trigger the discharge of the compressed fluid in the pneumatic or hydraulic cylinder when activated.

The activating means may be mechanical activating means, e.g. a lever or optical activating means, e.g. a photocell.

The switching means may be connected to the supporting plate.

The apparatus may further comprise a positioning rod. The positioning rod may be connected to the ground plate. The activating means may be connected to the ground plate through the positioning rod. The positioning rod is suitable for positioning the activating means at different positions along the preferred axis of translation.

The damping means comprise at least a spring.

The damping means are preferably symmetrically distributed over the surface of the ground plate and the supporting plate.

The ground plate and the supporting plate preferably have a rectangular shape.

The damping means are preferably distributed on two distal sides of the surface of the ground plate and the supporting plate.

### BRIEF DESCRIPTION OF THE DRAWINGS

The present invention is now described with reference to the attached drawings, which illustrate several non-limiting exemplary embodiments, wherein:

FIG. 1 is a prospective view of an apparatus for simulating a tire behavior in a plunger test;

FIG. 2 is a front view of the apparatus of FIG. 1.

FIG. 3 is a front view of the apparatus with the actuator piston in an extracted position and in contact with the plunger of the plunger test machine.

FIG. 4 is a perspective view of the apparatus with the actuator piston in an extracted position, the plunger in a displaced position during the test and the switching means engaging the activating means.

FIG. 5 is a side view of the apparatus of FIG. 4.

FIG. 6 shows the detail of FIG. 5 in which the switching means is engaging the activating means.

FIG. 7 exemplarily shows the force/displacement diagrams of two real tires and the apparatus respectively.

### DETAILED DESCRIPTION OF THE DRAWINGS

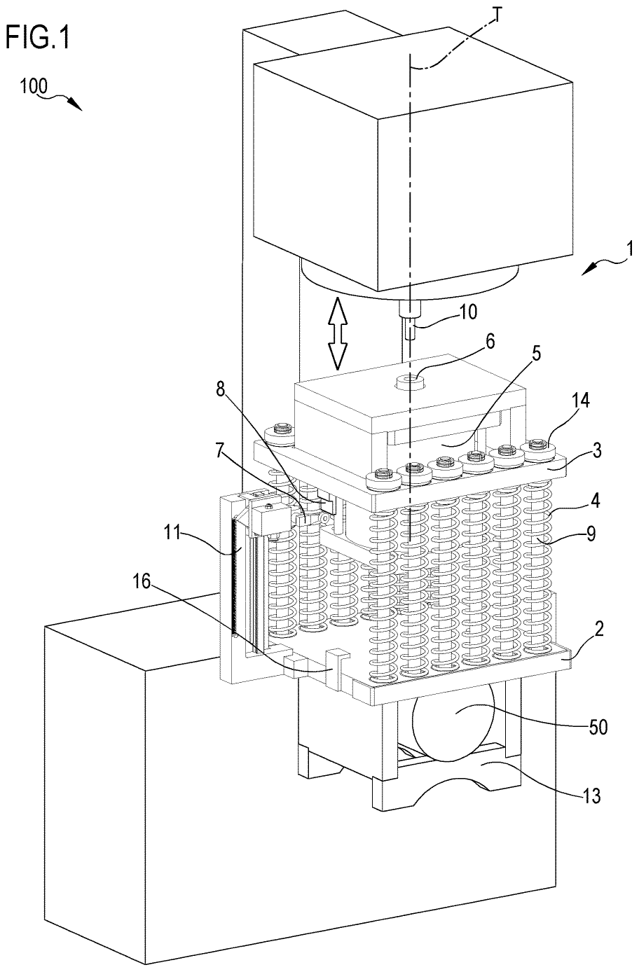

In FIG. 1, the number 1 indicates in the entirety thereof, an apparatus for simulating a tire behavior in a plunger test (also called a plunger test simulator tool).

The apparatus 1 is provided with a ground plate 2 that is firmly fixed to the tire supporting hub 50 of the plunger test machine 100 (only schematically shown) through fixing means 13. The fixing means 13 are preferably elongated bars passing below the tire supporting hub 50 and being fastened to the ground plate 2 preferably via screws, thereby fastening the tire supporting hub 50 between the ground plate 2 and the elongated bars.

To guarantee measurement precision it is important that the ground plate 2 of the apparatus 1 is firmly fixed on the tire supporting hub 50 of the plunger test machine 100 and that any movement of the ground plate 2 is inhibited.

The apparatus 1 further comprises a supporting plate 3 being movably connected to the ground plate 2 by damping means 4.

The damping means 4 extend from the upper surface of the ground plate 2 to the lower surface of the supporting plate 3.

The upper surface of the ground plate 2 and the lower surface of the supporting plate 3 are parallel to each other.

The supporting plate 3 is supported by the damping means 4.

The damping means 4 preferably comprise at least a spring.

The damping means 4 preferably comprise a plurality of springs.

In addition to supporting the supporting plate 3, the damping means 4 have the function of reproducing the vertical stiffness of a real tire.

Specific calibration of the damping means 4 is required to reproduce real tires of different sizes or, more in general, tires of different categories (passenger vehicle tires, commercial van tires, truck tires, etc.) as well as different inflation conditions.

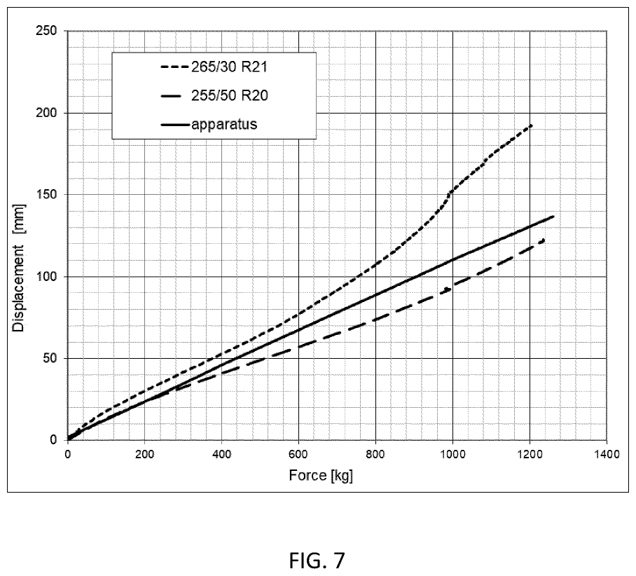

As can be seen in FIG. 7, during a plunger test the resulting displacement of the plunger 10 according to the force applied to the tire are plotted. The average slope of the resulting graph is the vertical stiffness of a tire and represents its spring constant k.

In FIG. 7 the solid line represents the plunger test results with the apparatus for simulating a tire behavior in a plunger test whereas the dashed line shows the result on a real tire of the size 255/50 R20 having a resulting spring constant of about 10.5 kg/mm and the dotted one the result of a real tire of the size 265/30 R21 having a resulting spring constant of about 7.5 kg/mm. Both tires were inflated at 2.0 bar. The spring constant of the damping means 4 is about 8.9 kg/mm.

With calibration of the damping means 4 it is meant that the total spring constant of the damping means 4 should represent the range of spring constants of a particular tire type.

The table below shows possible ranges of spring constants of different tire categories.

TABLE I

| Tire category | Range of spring constant [kg/mm] |
|---|---|
| Passenger Vehicle Tires | 5~12 |
| Commercial Van Tires | 13~22 |
| Truck and Bus Tires | 30~50 |

The damping means 4 should be calibrated and selected such that they can represent the vertical stiffness, i.e. the spring constant, of a category of tires.

It also possible to reproduce the exact spring constant of a specific tire size and specification once this is known.

In a preferred embodiment the damping means 4 consists of 12 single sprigs. Given the total spring constant k_{T} of the damping means 4 of 8.9 kg/mm, each single spring has a spring constant k_{S} of 0.74 kg/mm since in the embodiment shown in FIGS. 1 to 5 the springs of the damping means 4 have a parallel configuration.

The damping means 4 are arranged symmetrically over the upper surface of the ground plate 2 and the lower surface of the supporting plate 3 in order to evenly distribute the load of the supporting plate as well as the load applied during the plunger test.

The symmetric distribution of the damping means 4 allows also that the upper surface of the ground plate 2 and the lower surface of the supporting plate 3 remain parallel during the displacement of the supporting plate 2.

Preferably the ground plate 2 and the supporting plate 3 are of rectangular shape and have the same dimensions, i.e. the upper surface of the ground plate 2 and the lower surface of the supporting plate 3 have the same surface area.

Preferably the damping means 4 are distributed on two distal sides of the upper surface of the ground plate and the lower surface of the supporting plate respectively.

The damping means 4 connecting the supporting plate 3 to the ground plate 2 preferably allow a displacement only along a preferred axis of translation. The preferred axis of translation being orthogonal to both the upper surface of the ground plate 2 and the lower surface of the supporting plate 3.

To further assure the displacement of the supporting plate 3 only along the preferred axis of translation, the apparatus 1 preferably comprises guiding means 9.

The guiding means 9 extend in the preferred axis of translation and are fixedly connected with the ground plate 2.

The guiding means 9 are preferably rods or shafts, preferably with circular section.

Preferably the apparatus 1 comprises as many guiding means 9 as damping means 4.

Preferably the guiding means 9 and the damping means 4 are respectively coaxial, i.e. every single element of the guiding means 9 is coaxial to a single element of the damping means 4.

Preferably the guiding means 9 are located respectively axially inside the damping means 4, in other words each element of the damping means 4 surrounds an element of the guiding means 9.

The supporting plate 3 comprises at least one pass-through hole whose dimensions are such that the guiding means 9 can pass through it whereas the damping means 4 cannot.

The guiding means 9 comprise a limiting element 14 at its distal end from the ground plate 2. The limiting element 14 is located at the end of the guiding means 9 that passes through the pass-through hole in the supporting plate 3. The limiting element 14 is located on the opposite side of the supporting plate 3 than the damping means 4.

The limiting element 14 has firstly the function of securing the supporting plate 3 to the guiding means 9, or more precisely to secure that the supporting plate 3 would not move beyond the guiding means 9 and secondly of adjusting the initial compression of the damping means 4.

With initial compression of the damping means 4 it is meant the compression of the springs when no force is applied to the apparatus 1 via the plunger 10.

The limiting element 14 preferably comprises a ring and a bolt.

The limiting element 14 is preferably connected to the guiding means 9 via a thread.

The apparatus 1 further comprises a pneumatic or hydraulic actuator 5 being firmly connected to the supporting plate 3.

The pneumatic or hydraulic actuator 5 comprises an actuator piston 6.

The pneumatic or hydraulic actuator 5 is preferably a pneumatic or hydraulic cylinder.

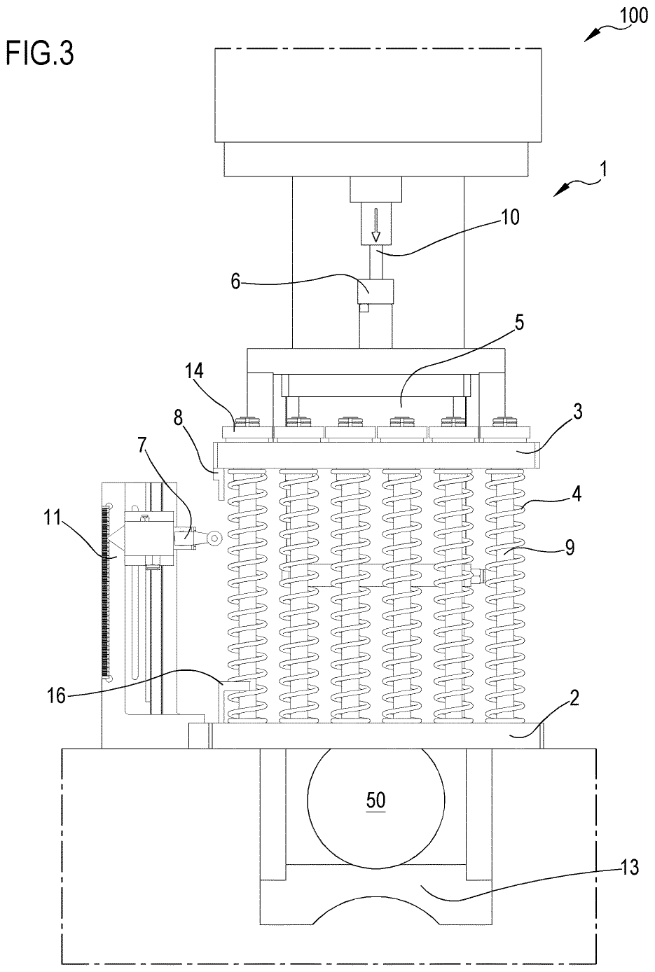

The pneumatic or hydraulic actuator 5 is suitable for being filled with a compressed fluid when in operation; when filled with the compressed fluid the pneumatic or hydraulic actuator 5 prompts the actuator piston 6 to translate in an extended position, as can be seen in FIG. 3.

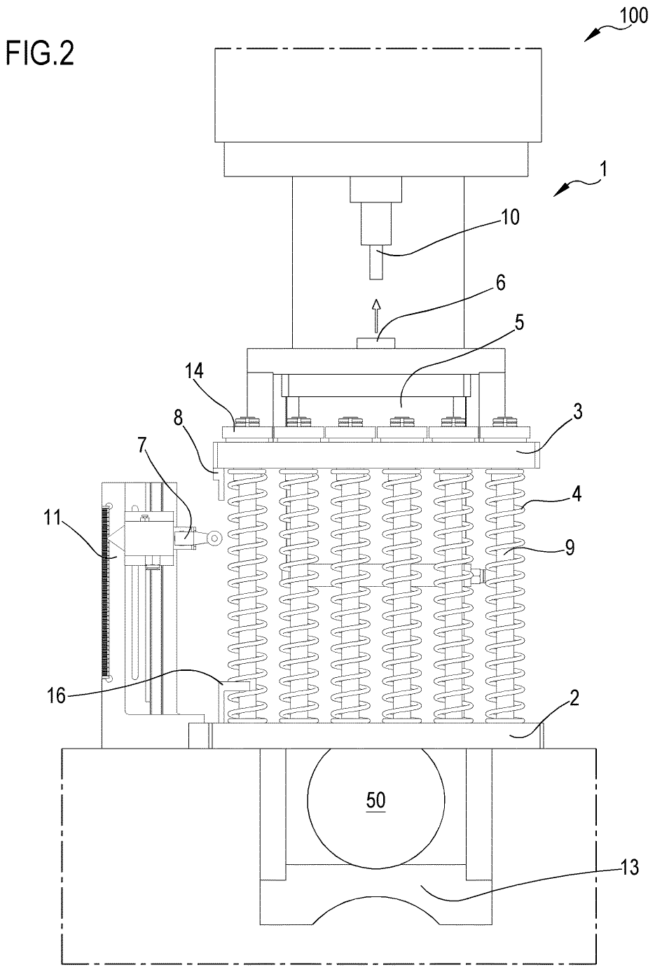

Vice-versa when the compressed fluid is discharged from the pneumatic or hydraulic actuator 5 the actuator piston 6 retracts in a retracted position, as can be seen in FIG. 1 or 2.

The translation axis T of the actuator piston 6 is parallel to the preferred axis of translation.

The apparatus 1 further comprises activating means 7 suitable to trigger the discharge of the pneumatic or hydraulic cylinder 5.

When the activating means 7 are engaged or activated, they prompt the pneumatic or hydraulic actuator 5 to discharge the compressed fluid, thereby simulating the breakage of the tire.

The activating means 7 are preferably mechanical activating means 7, e.g. a lever, or optical activating means 7, e.g. a photocell.

The activating means 7 are preferably connected to the ground plate 2.

The apparatus 1 may further comprise a positioning rod 11. The positioning rod is preferably connected to the ground plate 2.

The activating means 7 are preferably connected to the ground plate 2 through the positioning rod 11.

The positioning rod 11 is suitable for positioning the activating means 7 at different positions or heights along the preferred axis of translation T.

The apparatus 1 further comprises switching means 8 suitable to engage the activating means 7.

The switching means 8 are preferably connected to the supporting plate 3.

The switching means 8 are suitable to engage the activating means 7 at a predetermined displacement of the supporting plate 3.

The switching means 8 are configured to engage the activating means 7 to simulate the tire breakage.

The switching means 8 are configured to engage the activating means 7 at a predetermined displacement of the support plate 3 along its displacement 3.

The predetermined displacement of the support plate 3 corresponds to the displacement required to allow the switching means 8 to engage with the activating means 7.

The positioning of the activating means 7 at different positions or heights allows to select the predetermined displacement of the supporting plate 3 at which the switching means 8 will engage the activating means 7 and consequently the apparatus 1 will simulate the tire breakage.

The apparatus 1 may further comprise a displacement gauge 16 for measuring the displacement between the ground plate 2 and the supporting plate 3 during the plunger test.

The apparatus 1 may further comprise a load cell 17 (not shown in the figures) positioned on the outer end of the actuator piston 6, between the actuator piston 6 and the plunger 10.

The load cell 17 is suitable for measuring the applied force on the apparatus 1 simulating the behavior of a tire during the plunger test.

The measurement of the applied force via the load cell 17 and the displacement between the ground plate 2 and the supporting plate 3 will provide a way to calculate the energy required to break the tire during the plunger test.

The measurement of force and displacement via the load cell 17 and the displacement gauge 16 will provide comparative data in addition or in substitution of those measured by the plunger test machine itself. The additional comparative dataset can be used also to check the proper function of the plunger test machine.

In operation, the apparatus 1 is mounted on the tire supporting hub 50 of a plunger test machine 100; the pneumatic or hydraulic actuator 5 is filled with a compressed fluid, this prompts the actuator piston 6 to translate in its extended position. Before starting the plunger test, the plunger 10 of the plunger test machine 100 is pushed against the actuator piston 6 as can be seen in FIG. 3.

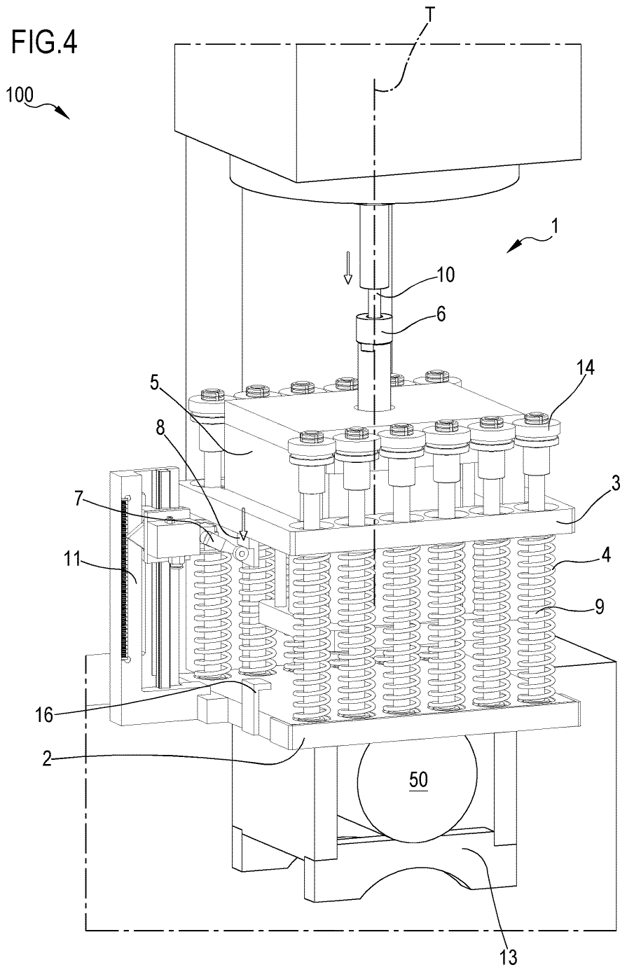

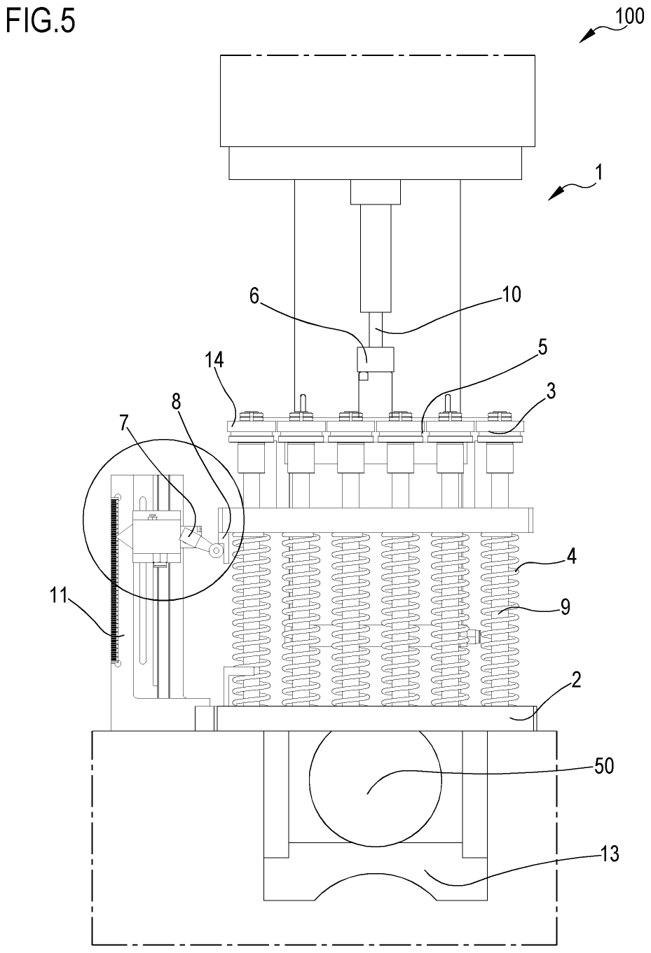

During the plunger test procedure a force is applied to the plunger 10 of the machine that consequently displaces the actuator piston 6 and the pneumatic or hydraulic actuator 5 as can be seen in FIGS. 4 and 5.

Being the pneumatic or hydraulic actuator 5 firmly connected to the supporting plate 3, the supporting plate 3 is pushed downwards, i.e. along the preferred axis of translation towards the ground plate 2.

The damping means 4 are thereby compressed.

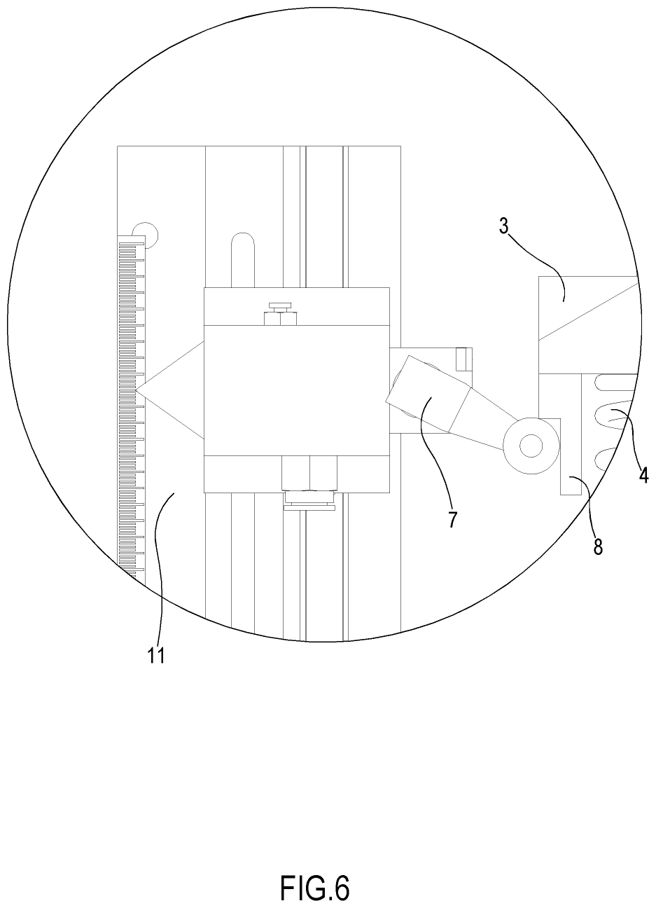

At a predetermined height the switching means 8 positioned on the supporting plate 3 will engage with the activating means 7 (as can be seen in FIGS. 5 and 6) thereby triggering the discharge of the compressed fluid from the pneumatic or hydraulic actuator 5 and simulating the breakage of the tire.

A method for simulating a tire behavior during a plunger test is also provided by this invention.

The method comprises using the apparatus 1 instead of a real tire during a plunger test.

The method comprising the steps of mounting the apparatus 1 onto the tire supporting hub 50 of a plunger test machine 100; filling the pneumatic or hydraulic actuator 5 with a compressed fluid, thereby prompting the actuator piston 6 to translate in its extended position; pushing the plunger 10 of the plunger test machine 100 against the actuator piston 6; starting the plunger test applying a force to the plunger 10; displacing the supporting plate 3 via the force applied to the actuator piston 6 until the switching means 8 will engage the activating means 7 thereby triggering the discharge of the compressed fluid from the pneumatic or hydraulic actuator 5 and simulating the breakage of the tire.

The method may further comprise the steps of applying a load cell 17 between the actuator piston 6 and the plunger 10; measuring the applied force and the displacement between the ground plate 2 and the supporting plate 3 during the test; calculating the energy at which the simulation of the tire breakage occurs.

### LIST OF REFERENCE NUMBERS IN THE FIGURES

1 apparatus
2 ground plate
3 supporting plate
4 damping means
5 pneumatic or hydraulic actuator
6 actuator piston
7 activating means
8 switching means
9 guiding means
10 plunger
11 positioning rod
13 fixing means
14 limiting element
15 tire supporting hub
16 displacement gauge
17 load cell
100 plunger test machine
T Preferred axis of translation

1-12. (canceled)

13. An apparatus for simulating a tire behavior in a plunger test, the apparatus comprising:
a ground plate configured to be fixed to a tire supporting hub of a plunger test machine;
a supporting plate being movably coupled to the ground plate by damping means, wherein the damping means allow a displacement only along a preferred axis of translation;
a pneumatic or hydraulic actuator coupled to the supporting plate, wherein the pneumatic or hydraulic actuator is configured to be filled with a compressed fluid when in operation and wherein the pneumatic or hydraulic actuator comprises an actuator piston;
activating means coupled to the ground plate and configured to trigger a discharge of the compressed fluid in the pneumatic or hydraulic actuator when activated;
a switch coupled to the supporting plate and configured to engage the activating means at a predetermined displacement of the supporting plate;
wherein the supporting plate is configured to be moved along the preferred axis of translation when a force is applied to the actuator piston.

14. The apparatus of claim 13, further comprising a positioning rod coupled to the ground plate, wherein the activating means are coupled to the ground plate through the positioning rod, and wherein the positioning rod is configured to position the activating means at different positions along the preferred axis of translation.

15. The apparatus of claim 13, wherein the damping means comprise one or more springs.

16. The apparatus of claim 13, wherein the damping means are symmetrically distributed over a surface of the ground plate and the supporting plate.

17. The apparatus of claim 16, wherein the damping means are distributed on two distal sides of the surface of the ground plate and the supporting plate respectively.

18. The apparatus of claim 13, wherein the pneumatic or hydraulic actuator is a pneumatic cylinder.

19. The apparatus of claim 13, further comprising a displacement gauge configured to measure a displacement of the supporting plate with respect to the ground plate.

20. The apparatus of claim 13, further comprising a load cell coupled to the actuator piston and configured to measure an applied force on the actuator piston.

21. The apparatus of claim 13, wherein the damping means have a spring constant in the range of 5 to 12 kg/mm.

22. The apparatus of claim 13, wherein the damping means have a spring constant in the range of 13 to 22 kg/mm.

23. The apparatus of claim 13, wherein the damping means have a spring constant in the range of 30 to 50 kg/mm.

24. A method for performing a plunger test on a plunger test machine using the apparatus of claim 13, the method comprising:
fixing the apparatus to a supporting hub of the plunger test machine;
filling the pneumatic or hydraulic actuator with a fluid, wherein the actuator rod is thereby lifted towards a plunger of the plunger test machine;
starting the plunger test by applying through the plunger a force onto the actuator piston causing the supporting plate to displace along the preferred axis of translation; and
ending the test when the switching means engage the activating means due to the displacement of the supporting plate.

25. The method of claim 24, further comprising:
measuring a displacement of the supporting plate via a displacement gauge;
measuring a force applied to the plunger via a load cell; and
calculating an energy at which the simulation of tire breakage occurs.

26. The method of claim 25, further comprising selecting the damping means having spring constants in the range 5 to 12 kg/mm.

27. The method of claim 25, further comprising selecting the damping means having spring constants in the range 13 to 22 kg/mm.

28. The method of claim 25, further comprising selecting the damping means having spring constants in the range 30 to 50 kg/mm.
